(19) United States
(12) Patent Application Publication
(10) Pub. No.: US 2005/0122894 A1
(43) Pub. Date: Jun. 9, 2005

(54) Method of controlling allocation of orthogonal variable spreading factor codes in a cellular radio network and control equipment for implementing the method

(75) Inventors: Thierry Lucidarme, Montigny Le Bretonneux (FR); Nidham Ben Rached, Paris (FR)

Correspondence Address: Michael L. Kenaga;PIPER RUDNICK LLP, P.O. Box 64807, Chicago, IL, 60664-0807, US

(73) Assignee: NORTEL NETWORKS LIMITED

(21) Appl. No.: 10/843,539

(22) Filed: May 11, 2004

(30) Foreign Application Priority Data
Dec. 5, 2003 (FR) FR 03 05712

(51) Int. Cl. H04J 11/00

(52) U.S. Cl. 370/208

(57) ABSTRACT

A set of orthogonal codes with variable spreading factor (OVSF), allocatable within a cell served by a base station of the access network, is organized according to a code tree. Mutually orthogonal codes of this set are selected in a control equipment of the base station to be allocated to radio channels between the base station and terminals in the cell. Statistical data are determined on the usage of the resources of the radio access network in the cell, in particular a mean duration of a user data transfer session between the radio access network and a terminal by means of at least one radio channel allocated in the cell, and these statistical data are brought into the selection of the codes of the set.

### BACKGROUND OF THE INVENTION

The present invention relates to cellular radio communications using code-division multiple access techniques (CDMA), and more particularly to procedures for allocating codes with variable spreading factor (OVSF, “Orthogonal Variable Spreading Factor”) used to distinguish between various channels in a cell.

The invention applies in particular, but not exclusively, to third-generation cellular systems of UMTS type (“Universal Mobile Telecommunications System”).

The infrastructure of a cellular network comprises base stations distributed over the territory of coverage so as to communicate with terminals situated in the zones, or cells, that they serve. In a CDMA system, the digital symbols transmitted, binary (±1) or quaternary (±1±j), are multiplied by spreading codes composed of samples, called “chips”, whose rate is greater than that of the symbols. Orthogonal or quasi-orthogonal spreading codes are allotted to various physical channels sharing the same carrier frequency, so as to allow each receiver to detect the sequence of symbols which is destined therefor, by multiplying the signal received by the corresponding spreading code.

In a UMTS system, the spreading code employed on a downlink physical channel is the product of a scrambling code assigned to the transmitting cell and of a “channellization” code.

The scrambling codes are orthogonal from one cell to another. Several orthogonal scrambling codes may possibly be allocated to one and the same cell.

The “channellization” codes serve to distinguish between various channels within a cell. When these channels have different symbol throughputs, these “channellization” codes exhibit different spreading factors (the spreading factor is the ratio of the chip rate to the symbol rate on the channel). They are then chosen from a set of OVSF codes which, for each scrambling code assigned to the cell, is organized according to a binary tree each stage of which corresponds to a possible value of the spreading factor. Each node in this tree represents a code and is associated with two daughter nodes with twice the spreading factor belonging to the next stage. In the last stage of the tree, the nodes (leaves) represent the codes of maximum spreading factor. Two OVSF codes of the binary tree fulfil the condition of orthogonality on condition that one is not a descendant of the other.

The allocation of the OVSF codes to the communication channels is controlled in such a way so as to comply with this condition of orthogonality between all the codes allocated at each instant. As the allocation to a channel of a code of the tree corresponding to a given node renders this node's ascendant and descendant nodes unavailable for the allocation of codes to other channels, the allocation algorithm used will have a greater or lesser probability of leading to blockage situations, i.e. to situations where there are no longer any codes available for a new channel to be established although the maximum throughput capacity of the code tree has not been reached.

By way of example, consider an instant at which K/2 codes of maximum spreading factor SFₘₐₓ are allocated, K being the number of leaves of the tree. If these codes are grouped together in the first half of the tree (they have a common ascendant), the other half remains available for the establishment of other channels of spreading factor lower than SFₘₐₓ. On the other hand, if these codes are completely dispersed (the K/2 nodes do not include any pair of sister nodes), the tree no longer exhibits any code with spreading factor less than SFₘₐₓ orthogonal to each of the K/2 codes, so that there is blockage.

An effective allocation algorithm therefore avoids allocating codes overly dispersed in the tree. It does not suffice to do so at the moment at which the channels are set up since the allocator does not control the random releasing of these channels. A well-filled tree (for example the K leaves allocated) can retain its good properties upon the releasing of channels (for example releasing of K/2 codes having a common ascendant) or on the contrary lead to undesirable situations of blockage (for example releasing of K/2 completely dispersed codes).

To combat such blockages, the allocation algorithm can undertake rearrangements or reallocations of codes to channels currently in use.

These reallocations improve the availability of the codes for new channels. However, they have the drawback of generating a significant quantity of signalling within the access network and on the radio interface so as to provide the base stations and the terminals with the instructions required to effect the change of code.

On account of this drawback, an optimal algorithm (for example that described by T. Minn and K. Y. Siu in “Dynamic Assignment of Orthogonal Variable-Spreading-Factor Codes in W-CDMA”, IEEE Journal on Selected Areas in Communications, Vol. 18, No. 8, August 2000, pp. 1429-1440) may turn out to be inadequate in situations where the dynamics of creation and of disappearance of the channels renders blockages improbable.

Moreover, the time taken by the allocation or rearrangement process may reduce the effectiveness of the algorithm if the mean frequency of creation and of disappearance of the channels is high.

Other examples of algorithms for allocating OVSF codes are described in the following publications:
R. G. Cheng, et al., “OVSF Code Channel Assignment for IMT-2000”, IEEE Vehicular Technology Conference, Vol. 3, 2000, pp. 2188-2192;
R. Assaru, et al., “Region Division Assignment of Orthogonal Variable-Spreading-Factor Codes in W-CDMA”, IEEE Vehicular Technology Conference, 2001, Vol. 3, pp. 1884-1888;
C. E. Fossa, et al., “A Dynamic Code Assignment Algorithm for Quality of Service in 3G Wireless Networks”, IEEE Wireless Communications and Networking Conference, 2002, Vol. 1, 17-21 Mar. 2002, pp. 1-6.

An object of the present invention is to alleviate the drawbacks mentioned above by controlling the allocation of OVSF codes in a cell in a powerful manner when it is useful and while avoiding needlessly loading the access network with signalling when it can be dispensed with.

### SUMMARY OF THE INVENTION

The invention thus proposes a method of controlling allocation of orthogonal variable spreading factor codes in a code-division multiple access radio access network, wherein a set of codes allocatable within a cell served by a base station of the access network is organized as at least one code tree. The method comprising the steps of: selecting mutually orthogonal codes of the set in an equipment controlling the base station, to be allocated to radio channels between the base station and terminals in the dell; and determining statistical data on the usage of the resources of the radio access network in the cell, including a mean duration of a user data transfer session between the radio access network and a terminal by means of at least one radio channel allocated in the cell. The statistical data are taken into account in the step of selecting codes of the set.

This method makes it possible to match the procedure for allocating the codes to the needs of each cell. In general, the dynamics of creation and of disappearance of the radio channels in this cell will be examined, and it will be translated into statistical data representing in particular the mean duration of a session and possibly complementary data, for example on the statistical distribution of the sessions of user data transfer between the radio access network and terminals by means of at least one radio channel allocated in the cell as a function of a communication throughput specified for these sessions, etc.

A small mean duration for the transfer sessions and a large proportion of sessions with low throughput, requiring channels with high spreading factor, are indices pointing to the fact that the cell under consideration has a “dynamic” profile in terms of usage of the resources of the OVSF tree or trees. In such a case, it is not generally relevant to devote much effort to the implementation of an optimal allocation algorithm since the latter will monopolize signaling resources and will achieve only a small operational gain.

Conversely, if the sessions tend often to be long and to have high throughput, it becomes useful to allocate the codes with care so as to be able to serve new communications.

The procedure for selecting the codes of the set can comprise a process of reallocation of codes of a tree to radio channels already established with terminals in the cell, so as to increase the availability of orthogonal codes in the tree. This reallocation process is advantageously executed in a more or less thorough manner, depending on the statistical data determined. In particular, the reallocation process may be disabled in cells where the statistical data indicate a dynamic profile.

The procedure for selecting the codes of the set can also comprise a separation of the set of codes into at least two parts of sizes dependent on the statistical data determined, these parts being subjected to different procedures for allocating codes. This allows particularly attentive management of a tree or a part of a tree reserved for certain communications, for example high throughput communications for which the risk of blockage is greater, and allows more coarse management (for example by not undertaking any rearrangement) of another tree or part of a tree whose codes will be allocated to communications at lower throughput. The relative importance of these two (or more) parts is advantageously matched to the statistical information compiled for the cell.

In another embodiment, the procedure for selecting the codes of the set comprises a reservation of a part of the set of codes for radio channels allocated during the adding of new radio links within the framework of sessions of user data transfer between the radio access network and terminals, the reserved part representing a fraction of the set dependent on the statistical data determined. These statistical data may then comprise the proportion of radio channels allocated in the cell during the adding of new radio links within the framework of sessions of user data transfer between the radio access network and terminals with respect to the set of radio channels allocated in the cell. This makes it possible, in the reserved part of the tree, to favor the allocation of codes to channels relating to communications that have already commenced in another cell, so as to avoid interrupting these communications. When the radio resources are almost saturated, it is better, for the perceived quality of the service, to refuse new communications than to allow communications in progress to be interrupted.

Another aspect of the present invention pertains to equipment for controlling at least one base station in a code-division multiple access radio access network, comprising: means for allocating orthogonal variable spreading factor codes to radio channels between the base station and terminals in a cell served by the base station, a set of codes allocatable within the cell being organized according to at least one code tree, wherein the allocation means are arranged to select mutually orthogonal codes of the set so as to allocate the selected codes to radio channels between the base station and terminals in the cell; and means for determining statistical data on the usage of the resources of the radio access network in the cell, including a mean duration of a user data transfer session between the radio access network and a terminal by means of at least one radio channel allocated in the cell. The statistical data are supplied to the allocation means to be taken into account in the selection of codes of the set.

### BRIEF DESCRIPTION OF THE DRAWINGS

FIG. 1 is a diagram of a UMTS network to which the invention may be applied;

FIG. 2 is a schematic showing the organization into layers of communication protocols employed on the radio interface of the UMTS network;

FIG. 3 is a schematic illustrating a set of codes for separating channels usable in a cell of the network.

### BRIEF DESCRIPTION OF THE DRAWINGS

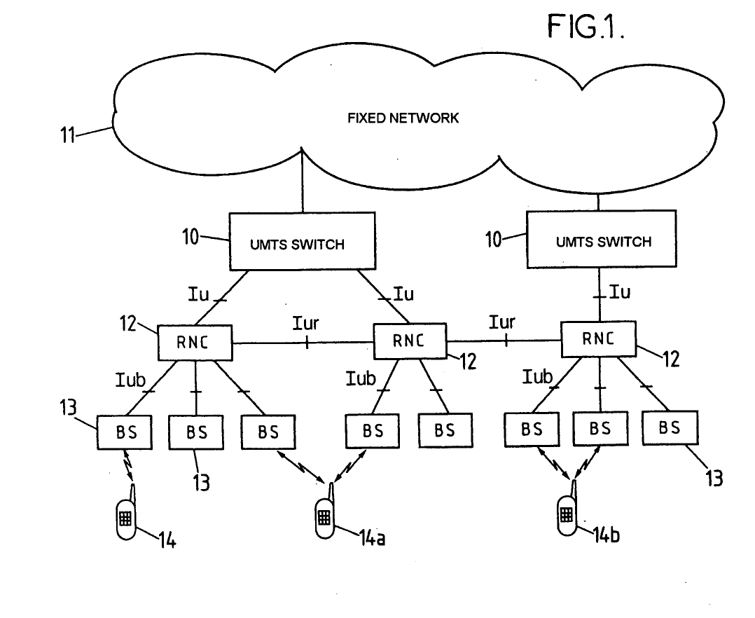

The invention is described herein below in its application to a UMTS network, of which FIG. 1 shows the architecture.

The switches of the mobile service 10, belonging to a core network (CN), are linked on the one hand to one or more fixed networks 11 and on the other hand, by means of a so-called Iu interface, to control equipment 12 or RNCs (“Radio Network Controllers”). Each RNC 12 is linked to one or more base stations 13 by means of a so-called Iub interface. The base stations 13, distributed over the territory covered by the network, are capable of communicating by radio with the mobile terminals 14, 14a, 14b called UE (“User Equipment”). The base stations 13, also called “node B”, can each serve one or more cells by means of respective transmitters/receivers. Certain RNCs 12 may furthermore communicate with one another by means of a so-called Iur interface. The RNCs and the base stations form an access network called UTRAN (“UMTS Terrestrial Radio Access Network”).

The UTRAN comprises elements of layers 1 and 2 of the ISO model with a view to providing the links required on the radio interface (called Uu), and a stage 15A for controlling the radio resources (RRC, “Radio Resource Control”) belonging to layer 3, as is described in the 3G TS 25.301 technical specification “Radio Interface Protocol” version 3.4.0 published in March 2000 by the 3GPP (3^{rd} Generation Partnership Project). In view of the higher layers, the UTRAN acts simply as a relay between the UE and the CN.

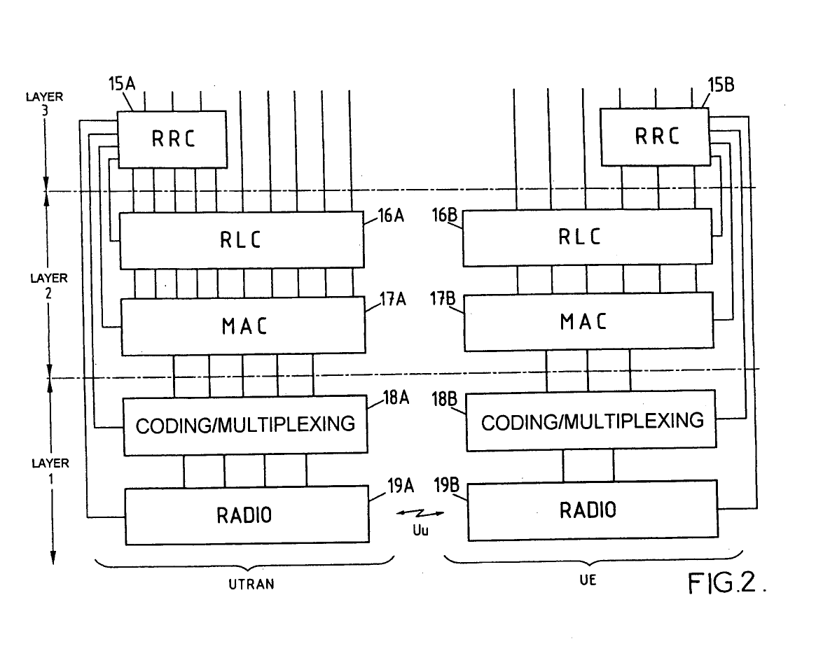

FIG. 2 shows the RRC stages 15A, 15B and the stages of the lower layers which belong to the UTRAN and to a UE. On each side, layer 2 is subdivided into a radio link control (RLC) stage 16A, 16B and a medium access control (MAC) stage 17A, 17B. Layer 1 comprises a coding and multiplexing stage 18A, 18B. A radio stage 19A, 19B caters for the transmission of the radio signals from trains of symbols provided by the stage 18A, 18B, and the reception of the signals in the other direction.

There are various ways of adapting the architecture of protocols according to FIG. 2 to the hardware architecture of the UTRAN according to FIG. 1, and in general various organizations can be adopted depending on the types of channels (see section 11.2 of the 3G TS 25.401 technical specification “UTRAN Overall Description”, version 3.1.0 published in January 2000 by the 3GPP). The RRC, RLC and MAC stages are located in the RNC 12. Layer 1 is located for example in node B 13. A part of this layer may however be located in the RNC 12.

When several RNCs are involved in a communication with a UE, there is generally a serving RNC called SRNC where the modules pertaining to layer 2 (RLC and MAC) are located, and at least one relay RNC called DRNC (“Drift RNC”) to which is linked a base station 13 with which the UE is in a radio link. Appropriate protocols cater for the exchanges between these RNCs over the Iur interface, for example ATM (“Asynchronous Transfer Mode”) and AAL2 (“ATM Adaptation Layer No. 2”). These same protocols can also be employed over the Iub interface for the exchanges between a node B and its RNC.

Layers 1 and 2 are each controlled by the RRC sublayer, whose characteristics are described in the TS 25.331 technical specification “RRC Protocol Specification”, version 4.1.0 published in June 2001 by the 3GPP. The RRC stage 15A, 15B supervises the radio interface. Moreover, it processes streams to be transmitted to the remote station according to a “control plan”, as opposed to the “user plan” which corresponds to the processing of the user data arising from layer 3.

In the UMTS jargon, a session of data transfer between a UE and the core network is called a “radio access bearer” (RAB). The RAB is defined with general attributes such as a class of quality of service (QoS), a maximum throughput, a guaranteed throughput, sizes of data units, an error rate, a transfer delay, etc. During the installation of an RAB, the RNC 12 is responsible for establishing a “radio bearer” (RB) for transferring user data between the UTRAN and the UE.

The parameters of the RB, which are not known to the core network, are a translation of the attributes of the RAB as a function of the capacities available to the UTRAN. They correspond to one or more transport channels each having a type, a mode of transfer (packet switching or circuit mode), a throughput, etc. The transposition of the logical channels arising from the RAB onto the transport channels thus defined is ensured by the MAC layer. The physical layer is then responsible for transposing the transport channels onto physical channels.

In general, the RNC will be configured to be able to establish RBs having a certain number of different types so as to adapt to the RABs requested. This number N may be of the order of a few tenths. Each type i of RB (1≦i≦N) will in particular be associated with a value of information throughput rᵢ.

With its SRNC, an active UE maintains an “RRC connection” through which it can exchange various signaling information items. The management of this RRC connection is described in section 8.1 of the aforesaid specification TS 25.331. Section 8.3 describes the mobility procedures involved within the framework of this RRC connection, in particular the way in which the RNC can update in respect of the UE an active set of cells with which there is a radio link. “Radio link” is understood here as the logical association between the UE and a cell. Such a link can support transmissions relating to one or more RBs, according to one or more physical channels. For each UE with which there is an RRC connection, the RNC knows the radio link or links in force.

The RB control procedures (setup, reconfiguration, release, etc.) are executed by the RNC in conjunction with the UE as described in section 8.2 of the aforesaid specification TS 25.331. Thus, the UE has available parameters useful for the operation of its RLC and MAC stages 16B, 17B as well as information on the configuration of the uplink physical channels useful for the operation of the coding and multiplexing stage 18B. The setup of an RB is requested by the RNC by means of the “RADIO BEARER SETUP” message (section 10.2.33 of the specification TS 25.331) and confirmed by the UE by means of the “RADIO BEARER SETUP COMPLETE” message (section 10.2.34). The release of an RB is requested by the RNC by means of the “RADIO BEARER RELEASE” message (section 10.2.30) and confirmed by the UE by means of the “RADIO BEARER RELEASE COMPLETE” message (section 10.2.31).

On the other hand, with each addition of a radio link with a new cell, the RNC informs the UE of the new channel or channels to be used by the “ACTIVE SET UPDATE” message of section 10.2.1 of the TS 25.331 specification, and the update is confirmed by the “ACTIVE SET UPDATE COMPLETE” message returned by the UE (section 10.2.2). The RNC also informs the base station responsible for the cell by means of the NBAP protocol implemented on the Iub interface (“Node B Application Protocol”, see section 8.3.1 of the 3G TS 25.433 technical specification, version 4.1.0, “UTRAN Iub Interface NBAP Signalling”, published in June 2001 by the 3GPP), by the “RADIO LINK ADDITION REQUEST” message (section 9.1.39 of the 3G TS 25.433 specification), and the addition of the link is confirmed by the “RADIO LINK ADDITION RESPONSE” message returned by the base station (section 9.1.40).

In an embodiment of the invention, the RNC maintains counters for each cell that it supervises, so as to determine statistical data on the usage made of the resources of the UTRAN by terminals having radio links with this cell. These counters can also be envisaged for other reasons in the RNC, for example for network operations, administration and maintenance (OAM) needs. For each type i of RB (1≦i≦N), the RNC can in particular keep trace of the following information gleaned over a given period (for example of the order of one or more days):
/1/ number aᵢ of RBs of type i successfully set up. This number is easily obtained by incrementing a counter with each event of receipt of a “RADIO BEARER SETUP COMPLETE” message relating to an RB of type i from a UE having a radio link with the cell;
/2/ number bᵢ of radio links added between a UE having an RB of type i in progress and the cell. This number is easily obtained by incrementing a counter with each event of reception of an “ACTIVE SET UPDATE COMPLETE” message from the UE after an “ACTIVE SET UPDATE” message requesting the addition of the cell to the active set, or with each event of reception of the “RADIO LINK ADDITION RESPONSE” message from the base station after a “RADIO LINK ADDITION REQUEST” message relating to the UE;
/3/ mean duration dᵢ of maintenance of an RB of type i with a radio link between a UE and the cell. After detection of an event such as indicated under /1/ or /2/, the RNC triggers a time counter which it stops either on receipt of the “ACTIVE SET UPDATE COMPLETE” message from the UE after an “ACTIVE SET UPDATE” message requesting that the cell be removed from the active set, or on receipt of the “RADIO BEARER RELEASE COMPLETE” message relating to the RB from the UE. The mean of the values of this time counter over the period corresponds to the mean duration dᵢ.

The number cᵢ=aᵢ+bᵢ represents the number of RBs of type i for which physical channels must be set up in the cell in a period. This number can also be obtained by counting the events of reception of the “ACTIVE SET UPDATE COMPLETE” message relating to the cell from a UE having an RB of type i already set up or currently being set up.

The number

$${p}_{i} = \frac{{c}_{i}}{{\sum }_{j = 1}^{N} {c}_{j}}$$

represents the mean proportion, over the period, of the RBs of type i with respect to the set of RBs relating to the cell.

The quantity

$$\overline{r} = {\sum }_{i = 1}^{N} {p}_{i} \cdot {r}_{i}$$

represents the mean throughput of an RB for which a radio link in the cell is used.

The quantity

$$P ( R ) = {\sum }_{{r}_{i} \geq R}^{} {p}_{i}$$

represents the proportion of RBs whose throughput is at least equal to R.

The number

$${q}_{i} = \frac{{b}_{i}}{{c}_{i}}$$

represents the proportion of radio channels allocated in the cell when new radio links are added within the framework of RBs of type i already set up, with respect to the set of radio channels allocated in the cell and involved within the framework of RB of type i. The number

$$q = \frac{{\sum }_{i = 1}^{N} {b}_{i}}{{\sum }_{i = 1}^{N} {c}_{i}}$$

represents this same proportion for RBs of any type. A high value of the number q indicates that few new RBs are being set up in the cell, which recovers especially by handover of the RBs set up elsewhere.

The mean value

$$d = \frac{1}{N} {\sum }_{i = 1}^{N} {d}_{i}$$

represents the mean duration of maintenance of an RB of any type with a radio link between a UE and the cell.

The three counters above therefore allow a fairly rich statistical analysis of the dynamics of use of the resources of the UTRAN by terminals situated in a cell. It will be noted that other counters could be envisaged for further enriching this statistical analysis or for performing it in some other way.

Each base station 13 forms, in a cell that it serves, a set of downlink physical channels by the CDMA technique. The information to be sent in the cell over a channel n forms the subject of a first spreading by a “channellization” code CCₙ and of a second spreading by a scrambling code.

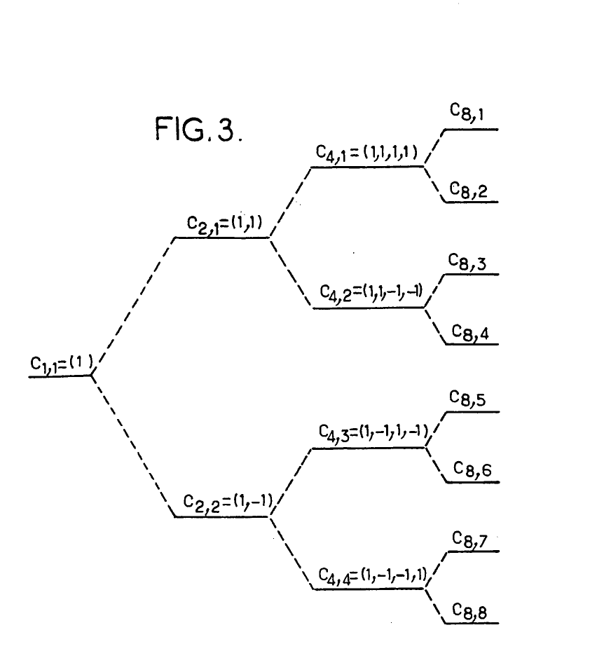

The codes CCₙ are orthogonal variable spreading factor (OVSF) codes. For each scrambling code, they are chosen from a set of codes of the type of the tree represented in FIG. 3. Each code c_{SF,i} (1≦i≦SF) is a sequence of SF samples, or chips, each taking the value _{±}1, with SF=2^{k}, k being an integer variable such that 0≦k≦L representing the rank of the code in the tree, and L a positive integer such that SFₘₐₓ=2^{L}. The tree is defined by:
c_{1,1}=(1),
C_{2.SF,2i-1}=(c_{SF,i}, c_{SF,i}),
c_{2.SF,2i}=(c_{SF,i}, −c_{SF,i}).

The chips of a channellization code C_{SF,i} have a rate D=3.84 Mchip/s. They modulate symbol streams whose rate is D/SF=D/2^{k}. The symbols in question are complex symbols each comprising two signed bits (of value _{±}1) corresponding to an I path and to a Q path.

The codes CCₙ are allotted to the channels n by the RNC 12. The codes allocated are chosen in such a way as to be globally orthogonal for one and the same cell. With the code tree of FIG. 3, two codes having the same spreading factor are always orthogonal, the sum of the chipwise products being zero. Two codes with spreading factors 2^{k} and 2^{k′}, are orthogonal, if, after they have modulated any two sequences of signed bits of respective rates D/2^{k} and D/2^{k′}, the resulting chip sequences are orthogonal. With the tree-like layout of FIG. 3, this amounts to saying that two channellization codes are orthogonal if and only if they do not belong to one and the same branch of the tree, going from the root c_{1,1} to a leaf c_{L,i}. The selection of the codes by the RNC 12 obeys this constraint in a global manner: the set of channellization codes CCₙ of a tree, that are used in the cell at the same instant by the base station 13, is such that two codes are not found on the same branch. This allows the mobile terminals to discriminate between the physical channels which relate to them.

The RNC 12 identifies the OVSF code to be employed for each physical channel, and informs the base station thereof by means of the NBAP protocol (“RADIO LINK ADDITION REQUEST” message) and the terminal by means of the RRC protocol (“ACTIVE SET UPDATE” message).

According to the invention, the method of selection by the RNC of the OVSF code to be allocated to a channel depends on the statistical data determined for the cell of the radio link supporting the channel. By way of example, three algorithms for allocating codes are available to the RNC.

The first algorithm is used for cells possessing a “dynamic” profile. It performs a non-predictive allocation of code, i.e. it does not attempt to evaluate which code of rank k is the one that maximizes the remaining throughput after allocation. It chooses this code at random from among the codes of rank k available in the tree, or as the first code encountered with rank k during a sequential traversal of the tree. The profile of the cell being “dynamic”, the first algorithm never undertakes a rearrangement of the codes in the tree to maximize a certain criterion. Undertaking such rearrangements would be of little use and would be expensive in terms of signaling.

The second algorithm, highly predictive, is used for cells exhibiting a “static” profile. It may for example consist of the algorithm described in the aforesaid publication by T. Minn and K. Y. Siu. The position in the tree of a new code to be allocated to rank k is determined as being that whereby the most codes of smallest rank are left available in the tree. The profile of the cell being “static”, the second algorithm regularly undertakes, for example every five minutes, a complete rearrangement of the codes in the tree so as to maximize a certain criterion, such as for example that of the maximum available throughput. This allows the best possible serving of the probable forthcoming requests for RBs at high throughput. The rearrangement generally gives rise to exchanges of signaling between the RNC and certain UEs (ACTIVE SET UPDATE with indication of one or more new codes and deletion of one or more codes used earlier), and between the RNC and the base station of the cell (RADIO LINK RECONFIGURATION).

The third algorithm, weekly predictive, is used for cells exhibiting a “semi-static” profile. It decides to choose as position of the new code to be allocated to rank k that whereby the most codes of rank k′<k are left available, where k′ corresponds for example to a throughput of 64 kbit/s or 128 kbit/s, without seeking to perform complete optimization in the OVSF code tree. The profile of the cell being “semi-static”, the second algorithm sometimes undertakes (every ten minutes for example) a rearrangement of the codes in the tree so as to maximize a certain criterion, for example that of the maximum available throughput. However, this rearrangement is not performed by backtracking as far as the root of the tree, but only as far as rank k′. This rank k′ can depend on the mean throughput \overline{r} defined previously; the higher the mean throughput \overline{r} of the RBs in the cell, the more the process for reallocating the codes is made to backtrack towards the root of the tree (k′ decreases).

The “dynamic”, “static” or “semi-static” classification of a cell is made via its home RNC(CRNC, “controlling RNC”) as a function of the statistical data mentioned above. Various classification criteria may be employed.

A short mean duration of maintenance of an RB, for example d<1 min will for example give rise to a “dynamic” classification of the cell, whereas the other cells will be rated according to one or more additional criteria pertaining to the throughput distribution of the RBs. For example, if d>1 min and if there exists a proportion P(R1) of communications of RB at high throughput (R1=64 kbit/s or 128 kbit/s) greater than a first threshold S1 (25%) and a proportion P(R2) of communications of RB at very high throughput (R2=384 kbit/s) less than a second threshold S2 (5%), the cell may be rated “semi-static” (d>1 min, P(R1)>S1 and P(R2)<S2). If d>3 min and if there exists a proportion P(R2) of communications of RB at very high throughput (R2=384 kbps) less than another threshold S3 (20%), the cell may be rated “static” (d>3 min and P(R2)>S3). These additional criteria may be expressed in a very diverse manner depending on the needs of the operator of the access network. They may conveniently involve the mean throughput \overline{r}.

In another embodiment, as a function of the type of profile determined for the cell, the RNC can partition the code tree into several subtrees or take several scrambling codes with their respective trees, and assign these trees or subtrees respectively to various categories of RB, a category possibly comprising one or more of the aforesaid types of RB, grouped on the basis of throughput ranges. The size of the subtrees depends on the throughput distribution of the RBs.

By way of example, if the profile of the cell is “dynamic”, no partitioning of the tree managed according to the first algorithm above is carried out. If the profile is “semi-static” or “static”, then the higher the observed proportion P(R) of RBs of throughput greater than R, the larger the code subtree (that is to say with a root of rank k all the smaller) reserved for the RBs of throughput greater than a certain value R. For example: R=64 kbit/s; if P(R)>10%, we reserve ¼ of a tree; and if P(R)>25%, we reserve ½ a tree or we define a second scrambling code for which the code tree is reserved.

The subtree which is not reserved (low throughput) is managed in a semi-static manner, whereas the reserved subtree is managed in a “static” manner, in the above sense. The part reserved for the high throughputs is not made available for the allocation of physical channels relating to RBs of throughput lower than R.

At the RNC, it may be desirable to guarantee setups of new radio links (active set update by adding cells in macrodiversity mode) in a more reliable manner than new RBs currently being set up. In this case, as a function of the proportion q defined above, a single tree is allotted, a tree is partitioned into two subtrees or two scrambling codes (two trees) are allotted. For example, if q>30%, two code trees of the same size are provided for the cell, one reserved for the channels added under macrodiversity to communications that are already underway in one or more other cells, and reserved for channels set up upon the opening of an RB, and just one tree is provided if q<30%. This precaution reduces the risk of having to interrupt communications in progress for lack of available codes in the new cells when the terminal moves.

1. A method of controlling allocation of orthogonal variable spreading factor codes in a code-division multiple access radio access network, wherein a set of codes allocatable within a cell served by a base station of the access network is organized as at least one code tree, the method comprising the steps of:
selecting mutually orthogonal codes of the set in an equipment controlling the base station, to be allocated to radio channels between the base station and terminals in the cell; and
determining statistical data on the usage of the resources of the radio access network in the cell, including a mean duration of a user data transfer session between the radio access network and a terminal by means of at least one radio channel allocated in the cell,
wherein said statistical data are taken into account in the step of selecting codes of the set.

2. The method as claimed in claim 1, further comprising authorizing reallocations of codes of the set to radio channels already established with terminals in the cell when said mean duration of session is greater than a threshold, and preventing the reallocations of codes when said mean duration of session is less than the threshold.

3. The method as claimed in claim 1, wherein said statistical data comprise data on the statistical distribution of sessions of user data transfer between the radio access network and terminals by means of at least one radio channel allocated in the cell as a function of a communication throughput specified for said sessions.

4. The method as claimed in claim 3, further comprising favoring reallocations of codes of the set to radio channels already established with terminals situated in the cell when said statistical data show a high proportion of high throughput sessions.

5. The method as claimed in claim 1, wherein the step, of selecting codes of the set comprises a process of reallocating codes of a tree to radio channels already established with terminals in the cell so as to increase the availability of orthogonal codes in the tree, said reallocation process being executed in a more or less thorough manner depending on the statistical data determined.

6. The method as claimed in claim 1, wherein the step of selecting codes of the set comprises a separation of the set of codes into at least two parts of sizes dependent on the statistical data determined, said parts being subjected to different procedures for allocating codes.

7. The method as claimed in claim 1, wherein the step of selecting codes of the set comprises a reservation of a part of the set of codes for radio channels allocated within the framework of high throughput user data transfer sessions between the radio access network and terminals, the reserved part representing a fraction of the set dependent on the statistical data determined.

8. The method as claimed in claim 1, wherein the step of selecting codes of the set comprises a reservation of a part of the set of codes for radio channels allocated during the adding of new radio links within the framework of user data transfer sessions between the radio access network and terminals, the reserved part representing a fraction of the set dependent on the statistical data determined.

9. The method as claimed in claim 8, wherein said statistical data comprise a proportion of radio channels allocated in the cell during the adding of new radio links within the framework of user data transfer sessions between the radio access network and terminals with respect to the set of radio channels allocated in the cell.

10. An equipment for controlling at least one base station in a code-division multiple access radio access network, comprising:
means for allocating orthogonal variable spreading factor codes to radio channels between the base station and terminals in a cell served by the base station, a set of codes allocatable within the cell being organized according to at least one code tree, wherein the allocation means are arranged to select mutually orthogonal codes of the set so as to allocate the selected codes to radio channels between the base station and terminals in the cell; and
means for determining statistical data on the usage of the resources of the radio access network in the cell, including a mean duration of a user data transfer session between the radio access network and a terminal by means of at least one radio channel allocated in the cell,
wherein said statistical data are supplied to the allocation means to be taken into account in the selection of codes of the set.

11. The equipment as claimed in claim 10, wherein the allocation means are arranged to instruct reallocations of codes of the set to radio channels already established with terminals in the cell when said mean duration of session is greater than a threshold, without instructing reallocations of codes when said mean duration of session is less than the threshold.

12. The equipment as claimed in claim 10, wherein said statistical data comprise data on the statistical distribution of user data transfer sessions between the radio access network and terminals by means of at least one radio channel allocated in the cell as a function of a communication throughput specified for said sessions.

13. The equipment as claimed in claim 12, wherein the allocation means are arranged to favor reallocations of codes of the set to radio channels already established with terminals situated in the cell when said statistical data show a high proportion of high throughput sessions.

14. The equipment as claimed in claim 10, wherein the code selection performed by the allocation means comprises a process of reallocation of codes of a tree to radio channels already established with terminals in the cell so as to increase the availability of orthogonal codes in the tree, said reallocation process being executed in a more or less thorough manner depending on the statistical data determined.

15. The equipment as claimed in claim 10, wherein the code selection performed by the allocation means comprises a separation of the set of codes into at least two parts of sizes dependent on the statistical data determined, said parts being subjected to different procedures for allocating codes.

16. The equipment as claimed in claim 10, wherein the code selection performed by the allocation means comprises a reservation of a part of the set of codes for radio channels allocated within the framework of high throughput user data transfer sessions between the radio access network and terminals, the reserved part representing a fraction of the set dependent on the statistical data determined.

17. The equipment as claimed in claim 10, wherein the code selection performed by the allocation means comprises a reservation of a part of the set of codes for radio channels allocated during the adding of new radio links within the framework of user data transfer sessions between the radio access network and terminals, the reserved part representing a fraction of the set dependent on the statistical data determined.

18. The equipment as claimed in claim 17, wherein said statistical data comprise a proportion of radio channels allocated in the cell during the adding of new radio links within the framework of user data transfer sessions between the radio access network and terminals with respect to the set of radio channels allocated in the cell.
